(19) United States
(12) Patent Application Publication
(10) Pub. No.: US 2026/0303710 A1
(43) Pub. Date: Oct. 1, 2026

(54) METHOD AND SYSTEM FOR EFFICIENT DATA TRANSMISSION

(71) Applicant: HEWLETT PACKARD ENTERPRISE DEVELOPMENT LP, Spring, TX (US)

(72) Inventors: Zhenlei Wang, Beijing (CN); Liao Xu, Beijing (CN); Jianpo Han, Beijing (CN)

(21) Appl. No.: 19/093,478

(22) Filed: Mar. 28, 2025

(51) Int. Cl. H04L 69/22; H04L 65/1101

(52) U.S. Cl. CPC H04L 69/22; H04L 65/1101

(57) ABSTRACT

Examples described herein relate to a method for efficiently transmitting a first data unit comprising a first header and a second data unit comprising a second header. Both the first and second data units may belong to the same traffic session. A networking device may identify one or more candidate header fields having similar information in both the first header and the second header and generate a compact header by removing the candidate header fields from the second header. Then, the networking device inserts an availability bitmap into the compact header and replaces the second header in the second data unit with the compact header. The availability bitmap indicates which header fields from the second header have been included in the compact header. Then, the networking device may transmit the first data unit with its original header and the second data unit including the compact header.

### BACKGROUND

In a wireless local area network (WLAN), communication of frames such as Media Access Control (MAC) Protocol Data Unit (MPDU) or MAC Service Data Units (MSDUs) between a transmitting device and a receiving device involves a significant overhead due to the transmission of respective header control fields, need for an inter-frame space, and acknowledgment handling for the transmitted frames. With the increase in data rates, such overhead may incur increased airtime usage, thereby reducing airtime efficiency. Using a frame aggregation technique generally improves network throughput and airtime efficiency. With frame aggregation, multiple frames are combined into a single transmission. Accordingly, instead of transmitting frames individually, the transmitting device may transmit an aggregated frame unit (such as an aggregated MPDU (A-MPDU) or an aggregated MSDU (A-MSDU)) comprising multiple subframes. Depending on a negotiated acknowledgment policy, the receiving device may acknowledge receipt of the aggregated frame unit by transmitting a block acknowledgment to the transmitting device.

### BRIEF DESCRIPTION OF THE DRAWINGS

One or more examples in the present disclosure are described in detail with reference to the following Figures. The figures are provided for illustration purposes only and merely depict examples.

FIG. 1 depicts a block diagram of a wireless networking device, such as an access point (AP), capable of generating compact headers for data units, thereby efficiently transmitting the data units.

FIG. 2 depicts a block diagram of a receiving device, such as a client device, capable of restoring a full header from a compact header.

FIG. 3 depicts a flowchart of an example method for generating a compact header and efficiently transmitting data units.

FIG. 4 depicts a flowchart of another example method for generating a compact header and efficiently transmitting data units.

FIG. 5 depicts an example compact header.

FIG. 6 depicts an example aggregated data unit, such as an example A-MPDU.

FIG. 7 depicts a flowchart of an example method for restoring a full header from a compact header.

FIG. 8 depicts a flowchart of yet another example method for restoring a full header from a compact header.

FIG. 9 depicts a block diagram of an example computing system.

The Figures are not exhaustive and do not limit the present disclosure to the precise form disclosed.

### DETAILED DESCRIPTION

A-MPDU and A-MSDU aggregation schemes as specified in the Institute of Electrical and Electronics Engineers (IEEE) in 802.11n, IEEE 802.11 ac, IEEE 802.11ax, and IEEE 802.11be Specifications provide efficiency gains by reducing overhead and enhancing throughput. For instance, the A-MPDU technique permits the transmission of multiple MPDUs within a single physical (PHY) frame. By aggregating MPDUs in a single frame, the overhead from the PHY preamble and header is amortized over multiple MPDUs, thereby increasing efficiency. Each MPDU within an A-MPDU includes its sub-frame header and Frame Check Sequence (FCS), which facilitates the selective retransmission of individual failed MPDUs rather than the entire aggregated unit. This capability significantly improves reliability and efficiency, especially in environments with varying signal quality.

Similarly, the A-MSDU technique enables the combination of multiple MSDUs into a single A-MSDU. These aggregated MSDUs share a common 802.11 MAC header, which reduces the overhead associated with individual MAC headers for each MSDU. Therefore, the A-MSDU aggregation minimizes the additional information transmitted in each MAC header, thereby increasing the transmission efficiency of the MAC layer. However, it is important to note that, unlike an A-MPDU transmission, if any part of an A-MSDU fails during transmission, the entire aggregated unit must be retransmitted, which can affect efficiency in certain scenarios.

As it is apparent, the efficiency of A-MPDU increases proportionally with the number of aggregated MPDUs, as the per-MPDU overhead is diminished when more units are transmitted together. Similarly, A-MSDU aggregation yields benefits by reducing the frequency of MAC headers, thereby lowering overall overhead. However, the choice between A-MPDU and A-MSDU depends on specific network conditions and the desired balance between throughput and reliability.

Despite the significant efficiency improvements provided by A-MPDU and A-MSDU aggregation techniques, certain notable challenges, such as the overhead associated with certain header fields, may persist. For example, each sub-frame (e.g., MPDU or MSDU) in an aggregated data unit (e.g., A-MPDU or A-MSDU) includes several headers such as Logical Link Control (LLC)/Sub-Network Access Protocol (SNAP) headers, Internet Protocol Version 4 (IPv4)/Internet Protocol Version 6 (IPv6) headers, and User Datagram Protocol (UDP)/Transmission Control Protocol (TCP) headers. These headers may largely remain identical for sub-frames within a common traffic session. For instance, in an A-MPDU frame, almost all sub-frames (i.e., MPDUs) include LLC/SNAP, IPv4/IPv6, and UDP/TCP headers. When these sub-frames are part of the same traffic flow or session, sharing the same 5-tuples (e.g., a source IP address, a source port number, a destination IP address, a destination port number, and a transport protocol (like TCP or UDP)), typically, the IP (IPv4/IPv6) and UDP/TCP headers are mostly identical, except for a few bits. Such redundancy may create considerable overhead, as each sub-frame may carry its respective headers. Consequently, even with aggregation techniques such as A-MPDU or A-MSDU, this repetitive header information in each sub-frame consumes valuable bandwidth, diminishing the overall efficiency gains that A-MPDU and A-MSDU aim to achieve.

In accordance with the examples presented herein, a method of improving transmission efficiency and air channel utilization by reducing certain overheads from headers such as LLC, IP, and TCP/UDP headers present in each sub-frame is presented. In some examples, the proposed method may be performed by a wireless networking device such as an access point (AP). The method begins with a processing resource of the AP receiving data units (e.g., MPDUs or MSDUs), for example, as a first data unit and a second data unit (sequentially or in parallel), for the same session, each with respective headers, such as a first header in first data unit and a second header in the second data unit. The processing resource then looks for header fields that contain the same information in both data units. After identifying these redundant header fields, the processing resource creates a smaller and more efficient compact header by removing the repetitive content from the second header (i.e., the original header of the second data unit). Further, in some examples, the processing resource may generate a session identifier based on the first data unit and insert the session identifier into the compact header along with an availability bitmap. The availability bitmap includes a flag corresponding to each header field of the second header, indicating whether respective content is present in the compact header. The AP may then replace the second header in the second data unit with the compact header.

After the second data unit is modified to replace its original header with the compact header, the processing resource may transmit the data units to a receiving device (e.g., a client device or any other wireless-capable device). In particular, the AP may transmit the first data unit with its original header and the second data unit with the compact header. In some examples, the AP may transmit the first and second data units in a single transmission of an aggregated data unit (e.g., an A-MPDU or A-MSDU) for efficient delivery. As will be appreciated, the transmission of the compact header in the second and subsequent data units of the same traffic flow minimizes overheads from the headers such as LLC, IP, and TCP/UDP headers, thereby maximizing the benefits of aggregation schemes such as A-MPDU and A-MSDU.

Furthermore, in some examples, the present disclosure proposes a method for restoring an original detailed header from the compact header by a networking device that receives the data units with compact headers, hereinafter referred to as a receiving device. When the receiving device receives an aggregated data unit (e.g., an A-MPDU or A-MSDU), the receiving device may extract the individual data units (e.g., the first data unit and the second data unit) from the aggregated data unit. The receiving device may then process the header of the first data unit to generate a verification session identifier, which the receiving device uses to find a match for the session identifier included in the compact header of the second data unit. When the receiving device finds a match, the receiving device may restore the second header from a compact header based on the availability bitmap and the detailed information from the first header. In particular, the availability bitmap serves as a guide to which parts of the header need to be retrieved from the first header.

Restoring the second header entails the receiving device analyzing the availability bitmap contained in the compact header to identify the header fields that need to be reconstructed. Based on the availability bitmap, the receiving device retrieves the relevant content from the first header's corresponding fields. Once the necessary data is retrieved, the receiving device inserts this copied content into the compact header, thereby restoring the second header from the compact header. This insertion process helps in accurately reconstructing the second header at the receiving device's end, ensuring the integrity and consistency of the transmitted data while minimizing redundancy during the transmission.

The following detailed description refers to the accompanying drawings. It is to be expressly understood that the drawings are for illustration and description only. While several examples are described in this document, modifications, adaptations, and other implementations are possible. Accordingly, the following detailed description does not limit the disclosed examples. Instead, the proper scope of the disclosed examples may be defined by the appended claims.

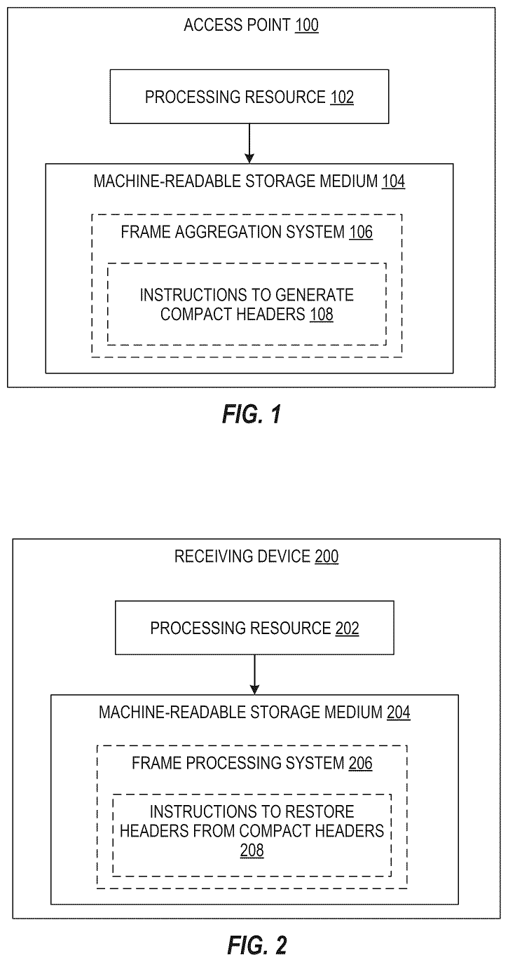

FIG. 1 illustrates a wireless networking device, for example, an access point (AP) 100 in which various of the examples presented herein may be implemented. The AP 100 may be implemented in any setup, for example, in a home setup or an organization, such as a business, educational institution, governmental entity, healthcare facility, or other organization. In particular, the AP 100 may be a networking device capable of providing wireless connectivity to the client devices thereby enabling the client devices to communicate with other electronic devices (not shown in FIG. 1). The AP 100 may include a combination of hardware, software, and/or firmware that is configured to provide wireless network connectivity to one or more client devices. In particular, the AP 100 may function as a point of access to the client devices connecting to the AP 100. In some examples, the AP 100 may comprise, be implemented as, or known as a radio router, radio transceiver, a switch, a Wireless-Fidelity (Wi-Fi) hotspot device, Basic Service Set (BSS) device, Extended Service Set (ESS) device, radio base station (RBS), or some other terminology and may act as a point of network access for the client devices connecting to the AP 100.

The AP 100 may be implemented with one or more radios to help the AP 100 communicate with the client devices and other wireless-capable devices. Each radio of the AP 100 may operate on the respective radio frequency range, referred to as a Wi-Fi band, such as the 2.4 Gigahertz (GHz) Wi-Fi band, 5 GHz Wi-Fi band, the 6 GHz Wi-Fi band, and so on. Although not shown in FIG. 1, in some examples, the AP 100 may be connected to one or more client devices and/or additional networking devices such as wireless local area network (WLAN) controllers, network switches, gateway devices, routers, and the like. Via the AP 100, the client devices may communicate with each other and/or with any other networking devices to which the AP 100 is communicatively connected.

The client devices connecting to the AP 100 may be electronic devices capable of wirelessly communicating with an AP 100 or other electronic devices. Examples of client devices may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, smart terminals, dumb terminals, virtual terminals, video game consoles, virtual assistants, Internet of Things (IoT) devices, and the like. Communications between the AP 100 and the client devices may be facilitated via wireless communication links established according to wireless communication protocols such as the IEEE 802.11 standards, Wi-Fi Alliance Specifications, or any other wireless communication standards. In some examples, the communication between the client devices and the AP 100 may be carried out in compliance with the IEEE 802.11 ax Specification.

In some examples, the data units communicated between the AP 100 and its connected devices (e.g., the client devices and other networking devices) may be frames such as MPDUs and MSDUs. In certain examples, the AP 100 may communicate the data units with the connected devices as aggregated data units, such as A-MPDU or A-MSDU. As previously noted, the A-MPDU and A-MSDU aggregation schemes as specified in the IEEE 802.11n, IEEE 802.11ac, IEEE 802.11ax, and IEEE 802.11be specifications provide efficiency gains by reducing overhead and enhancing throughput. In particular, the A-MPDU technique permits the transmission of multiple MPDUs within a single physical (PHY) frame. By aggregating MPDUs in a single frame, the overhead from the PHY preamble and header is amortized over multiple MPDUs, thereby increasing efficiency. This capability significantly improves reliability and efficiency, especially in environments with varying signal quality. Similarly, the A-MSDU technique enables the combination of multiple MSDUs into a single A-MSDU. These aggregated MSDUs share a common 802.11 MAC header, which reduces the overhead associated with individual MAC headers for each MSDU. Therefore, the A-MSDU aggregation minimizes the additional information transmitted in each MAC header, thereby increasing the transmission efficiency of the MAC layer.

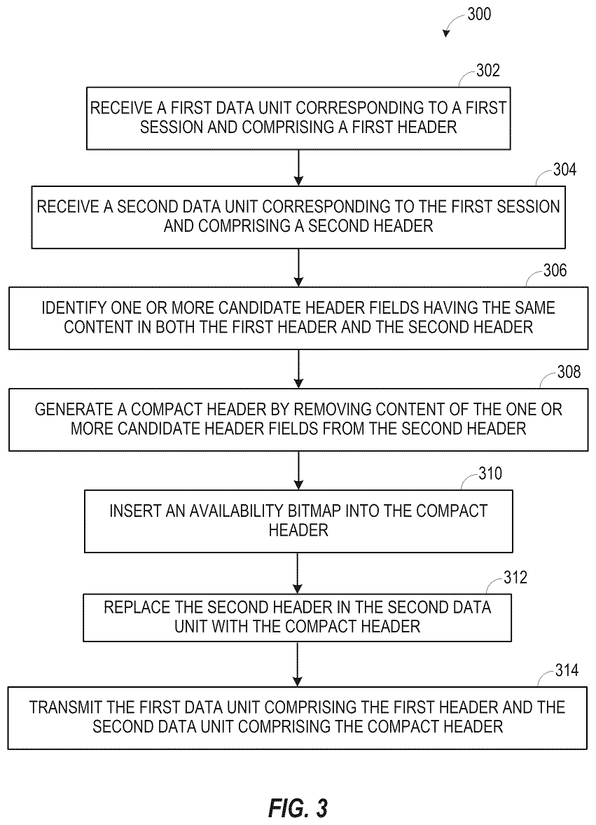

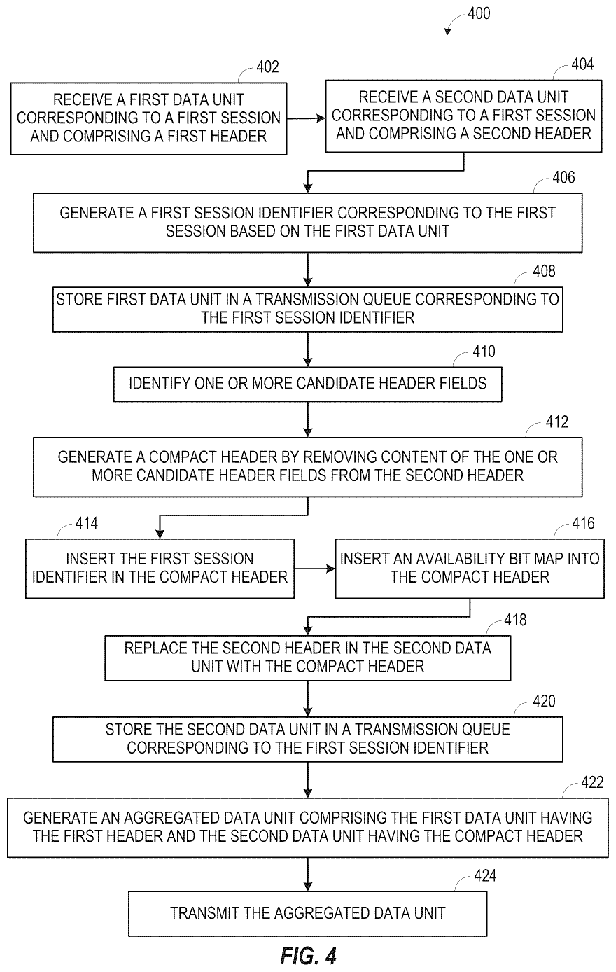

In some examples, the AP 100 may include a processing resource 102 and/or a machine-readable storage medium 104 for the AP 100 to execute several operations, as will be described in greater detail below. The machine-readable storage medium 104 is a non-transitory medium that is tangible and is alternatively referred to as a non-transitory machine-readable storage medium that does not encompass transitory propagating signals. The machine-readable storage medium 104 may be any electronic, magnetic, optical, or other storage device that may store data and/or executable instructions. Examples of the machine-readable storage medium 104 that may be used in the AP 100 may include Random Access Memory (RAM), non-volatile RAM (NVRAM), an Electrically Erasable Programmable Read-Only Memory (EEPROM), a storage drive (e.g., a solid-state drive (SSD) or a hard disk drive (HDD)), a flash memory, and the like. The machine-readable storage medium 104 may be encoded with executable instructions 108 (depicted using a dashed box in FIG. 1) for generating compact headers for the data units transmitted by the AP 100. Although not shown, in some examples, the machine-readable storage medium 104 may be encoded with certain additional executable instructions causing the processing resource to perform any other operations (e.g., operations described in conjunction with FIGS. 3-4) intended to be performed by the AP 100, without limiting the scope of the present disclosure.

The processing resource 102 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 104, or combinations thereof. The processing resource 102 may fetch, decode, and execute the instructions 108 stored in the machine-readable storage medium 104 to generate compact headers for the data units transmitted by the AP 100. As an alternative or in addition to executing the instructions 108, the processing resource 102 may include at least one integrated circuit (IC), control logic, electronic circuits, or combinations thereof that include a number of electronic components for performing the functionalities intended to be performed by the AP 100.

In some examples, the machine-readable storage medium 104 hosts, by way of storing respective program instructions and data, a frame aggregation system 106. The frame aggregation system 106, when executed by the processing resource 102 causes the processing resource 102 to generate compact headers for the data units, aggregate the data units in the form of an aggregated data unit, and transmit the aggregated data unit to one or more of the connected devices.

As previously noted, data units such as MPDUs and MSDUs generally include lengthy headers such as the Logical Link Control (LLC), Internet Protocol (IP), Transmission Control Protocol (TCP), and User Datagram Protocol (UDP) headers. It has been observed that these headers generally include certain header fields that remain redundant for data traffic belonging to a common traffic session. For example, LLC is a sublayer of the Data Link Layer (Layer 2) in the Open Systems Interconnection (OSI) model. The LLC sublayer is primarily responsible for managing communication over a single network link. It provides both connection-oriented and connectionless services. The LLC header is used in the IEEE 802 networks (such as Ethernet, Token Ring, and WLAN) to facilitate data communication. The LLC header typically contains three fields—a Destination Service Access Point (dsap), a Source Service Access Point (ssap), and a control field (ctl). Generally, all the content of the LLC header remains fixed for the data traffic corresponding to the same traffic flow.

The IP layer, often referred to as the network layer in the OSI model, is responsible for the logical addressing and routing of packets across network boundaries. The data units generally include respective IP headers to enable network-layer communication. The IP header is a data structure that stores addressing and control information for packets in an IP network (e.g., IPv4 network or IPv6). The IP header allows networking devices (e.g., the AP 100) to direct the packet to its destination. For example, an IPv4 header consists of several fields, some are shown in Table-1 below, along with their respective typical sizes.

TABLE 1
Typical header fields in an IPv4 header and respective sizes

| Header Field | Size (Byte) |
|---|---|
| Internet Header Length (IHL) & version | 1 |
| Type of service (tos) | 1 |
| Total length (tot_len) | 2 |
| Identification (id) | 2 |
| Fragment Offset (frag_off) | 2 |
| Time to Live (ttl) | 1 |
| Protocol (protocol) | 1 |
| Checksum (check) | 2 |
| Source IP Address (saddr) | 4 |
| Destination IP Address (daddr) | 4 |

Certain header fields in the IP header, such as ‘ihl,’ ‘version,’ ‘protocol,’ ‘check,’ ‘saddr,’ and ‘daddr,’ generally remain the same for the frames belonging to the same traffic flow. On the contrary, the ‘id’ field may be different for each frame. On the other hand, the header fields such as ‘tos,’ ‘tot_len,’ ‘frag_off,’ and ‘ttl’ may not always remain the same for the data traffic of the same traffic session. With the example header fields listed in Table 1, in one example, the IP header may have a length of 20 bytes.

Further, TCP is a connection-oriented protocol that provides reliable, ordered, and error-checked delivery of data units between applications running on hosts communicating over an IP network. The TCP header consists of several fields, some of which are shown in Table 2 below, along with their respective typical sizes.

TABLE 2
Typical header fields in a TCP header and respective sizes

| Header Field | Size (Byte) |
|---|---|
| Source Port (source) | 2 |
| Destination Port (dest) | 2 |
| Sequence number (seq) | 4 |
| Acknowledgment Number (Ack_seq) | 4 |
| Reserved (res), Data offset (doff), and nine | 2 |
| flags such as, Urgent Pointer (URG), | |
| Acknowledgment (ACK), Push function (PSH), | |
| Reset the connection (RST), Synchronize | |
| sequence number (SYN), No more data from | |
| sender (FIN), ECN-nonce - concealment | |
| protection (NS), Congestion Window | |
| Reduced (CWR), ECN-Echo (ECE) | |
| window | 2 |
| Checksum (check) | 2 |
| Urgent Pointer (urg_ptr) | 2 |

Certain header fields in the TCP header, such as ‘source,’ ‘dest,’ and ‘check,’ generally remain the same for the frames belonging to the same traffic flow. On the contrary, the ‘seq’ field may be different for each frame. On the other hand, the rest of the fields of the TCP header listed in Table 2 may not always remain the same for the data traffic of the same traffic session. With the example header fields listed in Table 2, in one example, the TCP header may also have a length of 20 bytes.

Furthermore, UDP is one of the core protocols of the IP suite. Unlike TCP, UDP is a connectionless protocol that provides minimal error recovery services. A UDP header is simpler compared to the TCP header and contains fewer fields. The UDP header fields are shown in Table 3 below, along with their respective typical sizes.

TABLE 3
Typical header fields in a UDP header and respective sizes

| Header Field | Size (Byte) |
|---|---|
| Source Port (source) | 2 |
| Destination Port (dest) | 2 |
| Length (len) | 2 |
| Checksum (check) | 2 |

Similar to the TCP header, the ‘source,’ ‘dest,’ and ‘check,’ fields also generally remain the same in the UDP header as well. Whereas the field ‘len’ may not always be the same for the data traffic of the same traffic session. With the example header fields listed in Table 3, in one example, the UDP header may have a length of 8 bytes.

If not controlled, the transmission of all such lengthy headers with such redundant information for a given traffic flow may consume increased airtime, thereby reducing overall transmission efficiency. To that end, the proposed AP 100 intelligently controls the transmission of information in such headers for efficient data transmission. In accordance with examples of the present disclosure, the AP 100 with the proposed frame aggregation system 106 is configured to generate compact headers for the frames that may be transmitted by the AP 100. In particular, the frame aggregation system 106 may generate compact headers by intelligently removing certain redundant information, such as the content of one or more header fields discussed hereinabove. For illustration purposes, the frame aggregation system 106 and items inside the frame aggregation system 106 are represented by the dashed outline as they represent digital entities that may be in the form of data and/or instructions that are executable by a physical processing resource, for example, the processing resource 102.

In some examples, the AP 100 receives data units, such as a first data unit and a second data unit, both belonging to the same traffic session, for transmission to intended recipients. The first data unit and the second data unit may include respective headers, for example, a first header and a second header. Because both the data units belong to the same traffic session, the respective headers may share certain redundant header fields. The proposed AP 100 may be configured to identify such redundant header fields across the first and second headers by comparing the respective header fields. The header fields whose content typically remains constant between the first header and the second header may be identified as candidates for optimization, for example.

After identifying these candidate fields, the AP 100 may generate a compact header by removing redundant information from the second header. This compact header retains unique information specific to the second header, significantly reducing the header's size and enhancing transmission efficiency. To ensure that the second header can be reconstructed in its original form at a receiving device, the AP 100 may insert an availability bitmap into the compact header. The availability bitmap includes flags corresponding to one or more header fields of the second header, indicating whether specific fields are present in the compact header, thus providing a concise map of the information retained.

The AP 100 may then replace the second header in the second data unit with the newly created compact header. By replacing the original, larger header with this optimized, smaller version, the AP 100 reduces bandwidth consumption and accelerates the transmission process. Finally, the AP 100 transmits the data units; in particular, the first data unit is transmitted with its original header (i.e., the first header), while the second data unit is transmitted with the compact header. Such a transmission of the data units, individually or as an aggregated data unit such as an Aggregated-MAC Protocol Data Unit (A-MPDU) or Aggregated-MAC Service Data Unit (A-MSDU), boosts both transmission efficiency and overall network performance.

As will be appreciated, the use of the compact header that includes certain selective fields from one or more of the LLC, IP, TCP, and or UDP headers reduces the overall sizes of the transmitted data units. For example, as noted earlier, for a common traffic session, the LLC header may be fully eliminated from subsequent data units following the first one.

Further, for an IP header such as an IP header with the example header fields depicted in Table 1 having a total size of 20 bytes, certain header fields in the IP header, such as, ‘ihl,’ ‘version,’ ‘protocol,’ ‘check,’ ‘saddr,’ and ‘daddr’ generally remain the same for the frames belonging to the same traffic session. Accordingly, all these fields can be eliminated, resulting in the maximum IP header size of 8 bytes, thereby achieving a 60% reduction in the size of the IP header. In an example situation, when the header fields such as ‘tos,’ ‘tot_len,’ ‘frag_off,’ and ‘ttl’ also found to be identical among the data units of the same traffic session, the IP header may be reduced to merely 2 bytes, thereby achieving a 90% reduction in the size of the IP header. Accordingly, using the proposed technique, the size of the IP header may be reduced from about 60% to 90% for the data traffic belonging to the same traffic session.

Furthermore, for a TCP header such as the TCP header having the example header fields depicted in Table 2 having a total size of 20 bytes, certain header fields such as, ‘source,’ ‘dest,’ and ‘check,’ generally remain the same for the frames belonging to the same traffic session. Accordingly, all these fields can be eliminated, resulting in the maximum TCP header size of 14 bytes, thereby achieving a 30% reduction in the size of the TCP header. In an example situation, when the header fields except ‘seq’ are found to be identical among the data units of the same traffic session, the TCP header may be reduced to merely 4 bytes, thereby achieving an 80% reduction in the size of the TCP header. Accordingly, using the proposed technique, the size of the TCP header may be reduced from about 30% to 80% for the data traffic belonging to the same traffic session.

Moreover, for a UDP header such as the UDP header having the example header fields depicted in Table 3 having a total size of 8 bytes, certain header fields such as, ‘source,’ ‘dest,’ and ‘check,’ generally remain the same for the frames belonging to the same traffic session. Accordingly, all these fields can be eliminated, resulting in the maximum UDP header size of 2 bytes, thereby achieving a 75% reduction in the size of the UDP header. In an example situation, when all of the header fields are found to be identical among the data units of the same traffic session, the UDP header may be fully eliminated, thereby achieving a 100% reduction in the size of the UDP header. Accordingly, using the proposed technique, the size of the UDP header may be reduced from about 75% to 100% for the data traffic belonging to the same traffic session.

Also, as will be understood, data units with smaller frame lengths (e.g., MPDUs and MSDUs having a frame length of 300 bytes) have a greater header overhead compared to the data units with comparatively larger frame lengths (e.g., MPDUs and MSDUs having a frame length of 1500 bytes). Accordingly, the proposed technique may achieve greater overall frame length reduction for the data units of smaller frame lengths compared to the data units of larger frame lengths. As will be appreciated, the header size reduction achieved by using the proposed techniques reduces the overall size of transmitted data units, thereby improving the transmission efficiency and the air channel utilization.

Additional details about generating the compact header and transmitting the data units are described in conjunction with FIGS. 3 and 4.

Referring to FIG. 2, presented is another networking device, also referred to as a receiving device 200, that is configured to restore a full header from a compact header. The receiving device 200 may be an electronic device capable of communicating with other devices using wireless communication protocols, for example, Wi-Fi communication standards. In some examples, the receiving device 200 may be a wireless networking device such as an AP, a radio router, a radio transceiver, a switch, a Wi-Fi hotspot device, a BSS device, an ESS device, a radio base station, a WLAN controller, a gateway device, and the like. In some examples, the receiving device 200 may be a client device capable of communicating with a wireless networking device, such as the AP 100 of FIG. 1. In certain examples, the functionalities of the receiving device 200 may be embedded into the AP 100 of FIG. 1 to enable the AP 100 to restore full headers of the data units containing compact headers.

To enable wireless communication capability, the receiving device 200 may also be implemented with one or more radios, allowing the receiving device 200 to communicate with other wireless-capable devices (e.g., the AP 100). Each radio of the receiving device 200 may operate on a respective range of radio frequency ranges, referred to as a Wi-Fi band, for example, the 2.4 Gigahertz (GHz) Wi-Fi band, 5 GHz Wi-Fi band, the 6 GHz Wi-Fi band, and so on. The radios of the receiving device 200 may support communications per wireless communication protocols such as the IEEE 802.11 standards, Wi-Fi Alliance Specifications, or any other wireless communication standards.

During operation, the receiving device 200 may receive aggregated data units such as A-MPDUs or A-MSDUs containing data units (e.g., MPDUs or MSDUs). Some of the received data units may contain compact headers, similar to the ones described in conjunction with FIG. 1. In accordance with some examples of the present disclosure, the receiving device 200 may be configured to restore the respective full headers from the compact headers. To aid in the restoration of the headers, the receiving device 200 may include a processing resource 202 and/or a machine-readable storage medium 204. The machine-readable storage medium 204 may host, by storing respective program instructions and data, a frame processing system 206. The frame processing system 206 may aid in restoring the full headers of the data units from the respective compact header, in particular, by intelligently restoring the content of certain header fields of the data units.

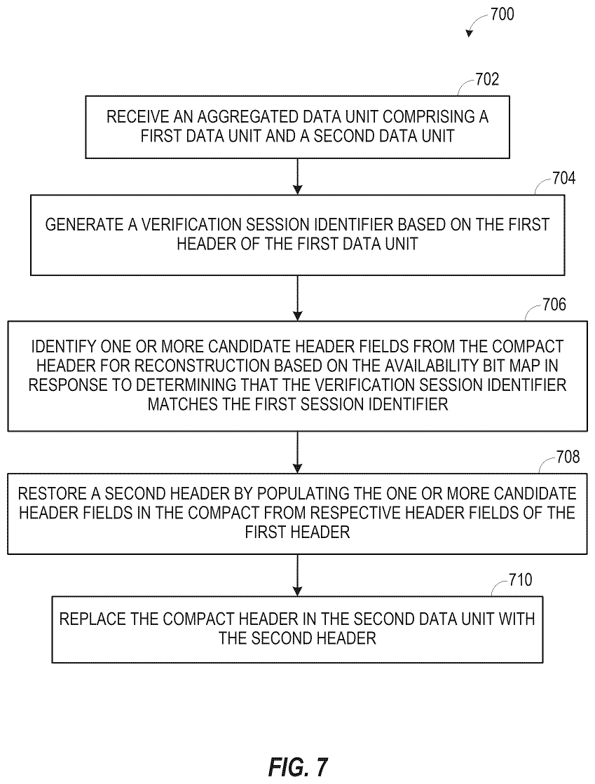

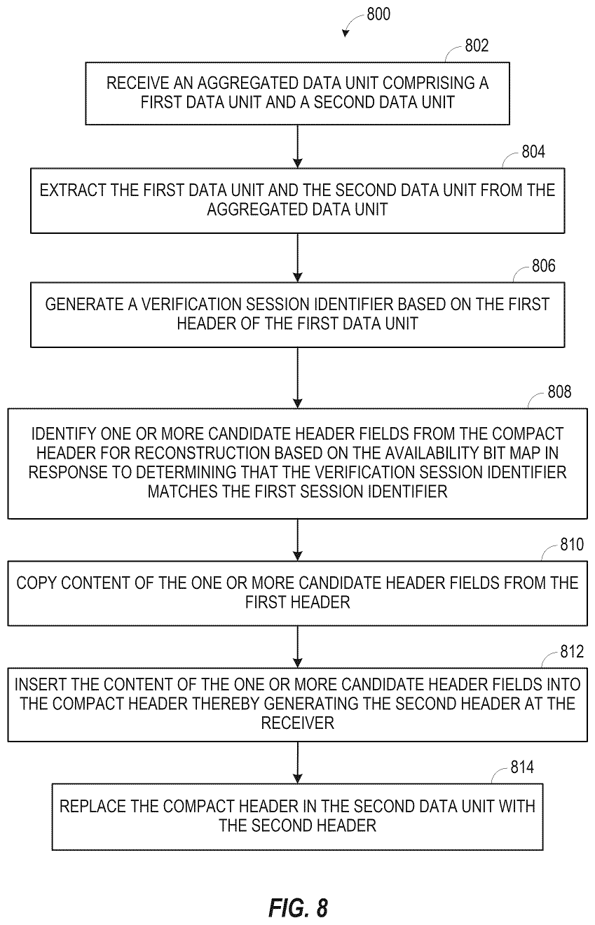

For illustration purposes, the frame processing system 206 and items inside the frame processing system 206 are represented by the dashed outline as they represent digital entities that may be in the form of data and/or instructions that are executable by a physical processing resource, for example, the processing resource 202. The processing resource 202 and the machine-readable storage medium 204 may be example representatives of the processing resource 102 and the machine-readable storage medium 104 of FIG. 1, details of which are not repeated herein for brevity. The machine-readable storage medium 204 may be encoded with executable instructions 208 (depicted using a dashed box in FIG. 2) for restoring full headers from the compact headers. Although not shown, in some examples, the machine-readable storage medium 204 may be encoded with certain additional executable instructions causing the processing resource 202 to perform any other operations (e.g., operations described in conjunction with FIGS. 7-8) intended to be performed by the receiving device 200, without limiting the scope of the present disclosure.

In some examples, the processing resource 202 executes the frame processing system 206 by executing the instructions 208 to restore the header information from the compact headers included in the received data units. The process of restoring a full header from a compact header involves several steps carried out by the receiving device 200 (e.g., by way of the processing resource 202 executing the instructions 208). First, the receiving device 200 receives an aggregated data unit, which could be either an A-MPDU or A-MSDU. This aggregated data unit includes a first data unit with a complete header (e.g., a first header) and a second data unit with a simplified, compact header. The compact header contains an availability bitmap showing which parts of the header are missing and a session ID to help identify the data flow. The receiving device 200 separates the aggregated data unit into individual data units and stores them for further processing.

Next, the receiving device 200 generates a verification session ID from the complete header of the first data unit by extracting key information like IP addresses and port numbers and running them through a hash function. The receiving device 200 may then compare the generated verification session ID with the session ID (e.g., a first session ID) included in the compact header to ensure both data units belong to the same traffic session. If they match, the receiving device 200 looks at the availability bitmap from the compact header to figure out which header fields need to be restored. The receiving device 200 then copies the missing information from the complete header (e.g., the first header) of the first data unit and inserts it into the compact header, thereby effectively rebuilding the full header (e.g., the second header). Finally, the receiving device 200 replaces the compact header in the second data unit with the restored full header, thereby ensuring the second data unit is complete and ready for further processing.

In the description hereinafter, various operations performed by a networking device, for example, the AP 100, are described with the help of flowcharts depicted in FIGS. 3 and 4. FIGS. 3 and 4 depict flowcharts of example methods for efficiently transmitting data units by the AP 100. The steps that are shown in FIGS. 3 and 4 may be performed locally at any suitable device, such as a wireless networking device (e.g., the AP 100 of FIG. 1). In some examples, a suitable device may include a processing resource suitable for retrieval and execution of instructions (e.g., the instructions 108) stored in a machine-readable storage medium. The processing resource and the machine-readable storage medium may be example representatives of the processing resource 102 and the machine-readable storage medium 104 of the AP 100 of FIG. 1. As an alternative or in addition to retrieving and executing instructions, the processing resource may include one or more electronic circuits that include electronic components for performing the functionality of one or more instructions, such as an FPGA, ASIC, or other electronic circuits. Further, the flow charts that are shown in FIGS. 3 and 4 include several steps in a particular order. However, the order of steps shown in the respective flowcharts should not be construed as the only order for the steps. The steps may be performed at any time in any order. Additionally, the steps may be repeated or omitted as needed.

FIG. 3 depicts a flowchart of an example method 300 for efficiently transmitting data units. The method 300 may be performed by a networking device, such as the AP 100 of FIG. 1.

At step 302, a networking device receives a first data unit for transmission to intended recipients. In some examples, receiving the first data unit at step 302 includes a processing resource of the networking device fetching the first data unit from a transmission repository. The transmission repository stores the data units to be transmitted by the networking device. In particular, the first data unit may belong to a first traffic session and includes a first header. A traffic session may be defined as a group of interactions between a source device and a destination device within a given time frame. Generally, in the data units belonging to a given traffic session (also alternatively referred to as traffic flow), certain session-specific parameters, such as a source IP address, a source port, a destination IP address, a destination port, and a protocol type used for communication between the two devices, may remain the same. By way of example, the first data unit may be a data frame such as an MPDU or an MSDU that includes a respective data payload and one or more headers, such as an LLC header, an IP header (e.g., an IPv4 header or an IPv6 header), or a TCP/UDP header.

Further, at step 304, the networking device receives a second data unit for transmission to the intended recipients. In some examples, the receiving of the second data unit at step 304 includes the processing resource of the networking device fetching the second data unit from the transmission repository. The second data unit may also belong to the first traffic session (also called a first traffic flow) and includes a second header. In certain examples, the processing resource of the networking device may determine that the second data unit also belongs to the first traffic session responsive to determining that the second data unit has the same session-specific parameters (e.g., the source IP address, source port, destination IP address, destination port, and protocol type) as that of the first data unit. The second data unit may also include respective data payload and protocol headers, such as LLC header, IP header (e.g., IPv4 or IPv6 header), or TCP/UDP header.

It may be noted that the networking device may receive the first data unit and the second data unit in a serial manner or in a parallel manner. Also, as previously noted, several header fields in each of the LLC header, the IP header, or the TCP/UDP header in the data units belonging to the same traffic session may be identical. Accordingly, at step 306, the networking device may identify one or more candidate header fields containing similar information in both the first header and the second header. To identify header fields that remain identical between the first header and the second header, the networking device may compare the respective header fields of the first header and the second header at step 306. This identification of the candidate header fields with redundant content between the data units of the same traffic session (e.g., the first traffic session) is useful in optimizing the data transmission, as will be described later. Common header fields that may be identified as candidates for optimization include source and destination addresses and protocol-specific information that remains constant throughout the session.

As previously noted, all three fields of the LLC header may generally remain the same for the data units belonging to the same traffic session. In the present example, as both the first data unit and the second data unit belong to the same traffic session (e.g., the first traffic session), all three fields of the LLC header, such as ‘dsap,’ ‘ssap,’ and ‘ctl’ will be identical in both the first header and the second header. Accordingly, the fields ‘dsap,’ ‘ssap,’ and ‘ctl’ of the LLC header may be determined as the candidate header fields.

Further, for the IP headers of the first data unit and the second data unit, certain header fields, such as ‘ihl,’ ‘version,’ ‘protocol,’ ‘check,’ ‘saddr,’ and ‘daddr’ generally remain the same for the frames belonging to the same traffic session. Therefore, the fields ‘ihl,’ ‘version,’ ‘protocol,’ ‘check,’ ‘saddr,’ and ‘daddr’ of the IP header may also be determined as the candidate header fields. Further, in another example, if comparison of the first header and the second header reveals that the fields ‘tos,’ ‘tot_len,’ ‘frag_off,’ and ‘ttl’ are also identical among the first header and the second header, in addition to the ihl,’ ‘version,’ ‘protocol,’ ‘check,’ ‘saddr,’ and ‘daddr’, the fields tos,′ ‘tot_len,’ ‘frag_off,’ and ‘ttl’ may also be determined as the candidate header fields.

Furthermore, for the TCP headers of the first data unit and the second data unit, certain header fields, such as ‘source,’ ‘dest,’ and ‘check,’ generally remain the same for the frames belonging to the same traffic flow, and may therefore be determined as the candidate header fields. Further, in another example, the fields except ‘seq’ in the TCP headers may be redundant among the frames belonging to the same traffic flow. Accordingly, all such fields with redundant content may be determined as the candidate header fields.

Moreover, for the TCP headers of the first data unit and the second data unit, certain header fields, such as ‘source,’ ‘dest,’ and ‘check,’ generally remain the same for the frames belonging to the same traffic flow, and may therefore be determined as the candidate header fields.

Such identification of the similarities between the header fields helps maintain the useful information while eliminating redundancy in the transmission of the data units, thereby making the communication process more efficient without compromising the accuracy or reliability of the data being transmitted. The identification of candidate header fields is a useful step that balances efficiency with the need to preserve the useful information required for successful data transmission.

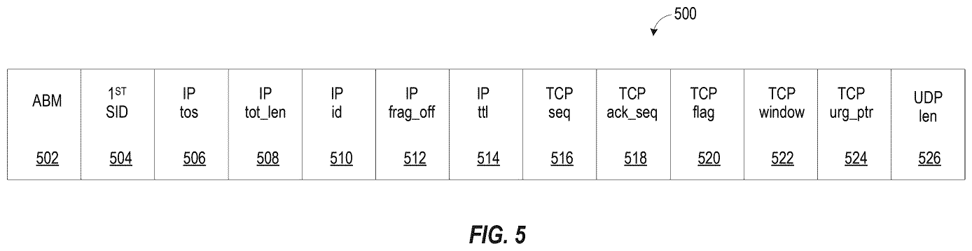

With the candidate header fields identified, the networking device proceeds to generate, at step 308, a compact header (see an example compact header depicted in FIG. 5, described later). This step involves creating a new, streamlined header by removing the redundant information from the second header. In particular, the compact header may be generated by removing the content of one or more candidate header fields from the second header. As a result, the newly generated compact header retains information that may be unique to the second header, thereby significantly reducing the size of the header and, consequently, the overall size of the data unit. The compact header is designed to improve transmission efficiency by minimizing the amount of header data that needs to be communicated. This reduction in header size speeds up the transmission process and frees up bandwidth for additional data, enhancing the overall network performance.

In order to keep track of the candidate header fields and help a receiving device restore the original header information, the networking device may include certain useful additional information in the compact header. For example, at step 310, the networking device may insert an availability bitmap into the compact header. The availability bitmap includes flags corresponding to one or more header fields of the second header, indicating whether the specific header fields are present in the compact header, providing a concise map of the information in the compact header. In particular, the availability bitmap acts as a guide, allowing the receiving device to understand which fields have been retained in the compact header and which have been omitted due to redundancy. This allows the receiving device to accurately restore full headers from the compact header (described with greater details in FIGS. 7-8).

After the compact header is updated with the availability bitmap, the networking device, at step 312, may replace the second data unit's original header (i.e., the second header) with the compact header. In particular, this step involves substituting the full, detailed second header in the second data unit with the newly created compact header. By replacing the larger original header with a smaller, optimized compact header, the device ensures that less bandwidth is consumed for transmitting the header information. This replacement of the lengthy second header with the compact header reduces the overall data size and improves the transmission efficiency.

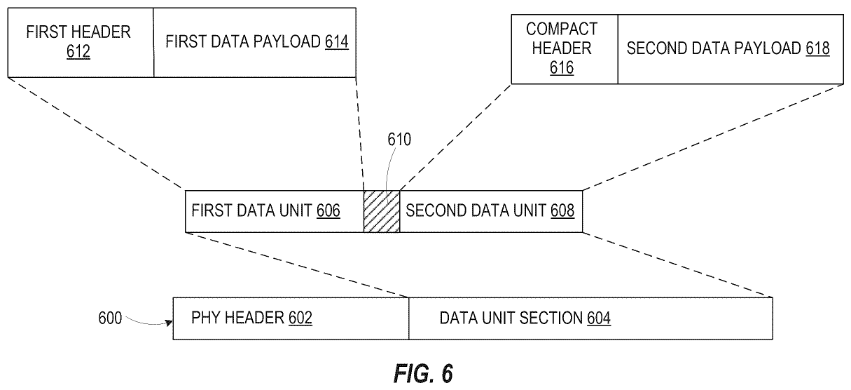

Finally, at step 314, the networking device may transmit the data units. In particular, the first data unit may be transmitted with its original first header, whereas the second data unit may be transmitted with the compact header. In one example implementation, the networking device may transmit the first data unit serially by transmitting the first data unit followed by transmitting the second data unit. In another example, the networking device may transmit the first data unit and the second data unit as an aggregated data unit, such as an A-MPDU or an A-MSDU (see an example aggregated data unit depicted in FIG. 6, described later).

Turning now to FIG. 4, a flowchart of another example method 400 for efficiently transmitting data units is presented. The method 400 may be performed by a networking device, such as the AP 100 of FIG. 1. The method 400 of FIG. 4 includes certain steps that are similar to those described in FIG. 3, certain details of which are not repeated herein for the sake of brevity.

At step 402, a networking device receives a first data unit for transmission to intended recipients. Similarly, at step 404, the networking device may receive a second data unit for transmission to the intended recipients. As previously noted, receiving the first data unit and the second data unit may entail the processing resource of the networking device fetching the first data unit and the second data units from a transmission repository. Both the first data unit and the second data unit may belong to the same traffic session, for example, the first traffic session. Also, the first data unit and the second data unit may include respective headers, such as a first header and a second header. Each of the first header and the second header may include one or more of an LLC header, an IP header (e.g., IPv4 or IPv6 header), a TCP header, or a UDP header. In some examples, the networking device may receive the first data unit and the second data unit in serially or parallelly.

Further, at step 406, the networking device may generate a first session identifier based on the first data unit. In particular, the networking device may generate the first session identifier, a unique session identifier for the traffic session associated with the first data unit. This process involves extracting specific header fields from the first header that may uniquely identify a traffic session associated with the first data unit. As previously noted, the session-specific parameters, such as a source IP address, a source port, a destination IP address, a destination port, and a protocol type, may collectively identify a given traffic session. The networking device then applies a predefined hash function to these extracted fields. Example hash functions that the networking device uses to generate the session identifier may include Secure Hash Algorithm (SHA)-1, SHA-2, SHA-3, SHA-256, Whirlpool, BLAKE2, BLAKE3, and/or Message Digest (MD) 5, or custom-designed hash functions. The resulting hash value serves as the session identifier, providing a unique and compact representation of the first traffic session.

To effectively manage the transmission of the data packets, the networking device maintains a separate transmission queue corresponding to different traffic sessions. In particular, transmission queues are data structures, often implemented as linked lists, circular buffers, or priority queues, which organize data units awaiting transmission. To effectively manage the transmission queue, a session identifier may be used as a key to place a given data unit in the correct queue, ensuring that all data units belonging to the same traffic session are transmitted in a predefined sequence. During the operation in the present example, after the first session identifier is generated, the networking device, at step 408, may store the first data unit in a transmission queue corresponding to the first traffic session that is uniquely identified by the first session identifier.

As noted earlier, certain header fields in each of the LLC, IP, or TCP/UDP headers in the data units belonging to the same traffic session may be identical. At step 410, the networking device may identify one or more candidate header fields that contain redundant information. In particular, the networking device may scan the second data unit's header (e.g., the second header) to identify which fields can be avoided for transmission, optimizing the header size without losing useful information. Fields that contain redundant information in both the first header and the second header are prime candidates for compaction. Several examples of the header fields that remain static across all data units of the same session are described in conjunction with step 304 of FIG, the description of which is not repeated herein for brevity. This step involves analyzing the second header's structure and contents, considering the protocol specifications and the session context. An efficient identification of candidate fields can significantly reduce the header size and improve transmission efficiency.

After the candidate header fields are identified, the networking device, at step 412, generates a compact header (see an example compact header depicted in FIG. 5, described later). This process involves creating a new, streamlined header by specifically removing redundant information from the second header. The compact header is generated by eliminating the content of the identified candidate header fields that are deemed unnecessary for each data unit within the same traffic session. For example, static fields that remain constant for all packets in the session can be excluded from the compact header, resulting in a compact header that retains information unique to the second data unit. This reduction in header size significantly decreases the overall size of the data unit, leading to improved transmission efficiency and reduced bandwidth usage.

Further, at step 414, the networking device inserts the first session identifier into the newly generated compact header. The first session identifier, generated at step 406, provides a unique reference to the first traffic session to which the second data unit belongs. Inserting the first identifier into the compact header ensures that the session context is preserved, even with the reduced header size. This identifier allows the networking device, as well as other devices in the network, to correctly associate the second data unit with its traffic session. This step involves modifying the compact header structure to include an information element that can be easily accessed and interpreted by a receiving device to restore full header information (see methods of FIGS. 7 and 8).

Furthermore, at step 416, the networking device inserts an availability bitmap into the compact header. The availability bitmap is a series of bits, with each bit representing the presence or absence of a corresponding header field of the second header, for example. The availability bitmap provides a concise way to indicate which header fields from the original header (e.g., the second header) have been included in the compact header and which header fields have been omitted. This availability bitmap is useful for reconstructing the original header whenever needed (for example, at a receiving device), ensuring that no critical information is lost during compaction. This step involves generating the bitmap based on the identified candidate fields and inserting it into the compact header.

Moreover, at step 418, the networking device replaces the second header in the second data unit (i.e., the original header of the second data unit) with the newly generated compact header. This step involves modifying the second data unit by substituting the full, detailed second header in the second data unit with the newly created compact header. This substitution of the original header with the compact header reduces the overall size of the data unit, thereby improving transmission efficiency.

Further, at step 420, the networking device may store the second data unit in the transmission queue after replacing the second header in the second data unit with the compact header. In particular, the networking device stores the modified second data unit, now with the compact header, in the same transmission queue as the first data unit. This ensures that both data units are transmitted in the correct order and within the same session context.

At step 422, the networking device may generate an aggregated data unit comprising the first data unit having the first header and the second data unit having the compact header (see an example aggregated data unit depicted in FIG. 6, described later). In some examples, the aggregated data unit generated at step 422 may be either an Aggregate MAC Protocol Data Unit (A-MPDU) or an Aggregate MAC Service Data Unit (A-MSDU). If the first data unit and the second data unit are MPDUs, the networking device may generate an A-MPDU as the aggregated data unit. Similarly, if the first data unit and the second data unit are MSDUs, the networking device may generate an A-MSDU as the aggregated data unit. As will be understood, this of the individual data units into the aggregated data unit enhances transmission efficiency in high-throughput wireless networks, such as those adhering to the IEEE 802.11n/ac/ax standards.

For A-MPDU generation, the networking device aggregates multiple MPDUs (e.g., the first data unit and the second data unit provided the first data unit and the second data unit are MPDUs) into a single transmission frame. Each MPDU retains its own MAC header and is encapsulated with a delimiter that allows the receiving device to identify and extract individual MPDUs, even if some errors occur during transmission. The MPDUs are concatenated together within the A-MPDU frame, which reduces the overhead of sending each MPDU separately. This method improves overall throughput by maximizing the use of available bandwidth and minimizing the contention overhead in the wireless medium.

For A-MSDU generation, the networking device aggregates multiple MSDUs into a single transmission frame called A-MSDU (e.g., the first data unit and the second data unit, provided the first data unit and the second data unit are MSDUs). This process involves the networking device encapsulating several MSDUs, which are higher-layer data units, into the payload of a single MPDU with a shared MAC header. The aggregated MSDUs share the same destination address and other pertinent attributes to be combined. By reducing the number of MAC headers transmitted, A-MSDU aggregation minimizes overhead and improves transmission efficiency. In both cases, the networking device ensures that the aggregated data unit (whether A-MPDU or A-MSDU) adheres to the maximum transmission unit (MTU) size and other relevant protocol constraints. The generated aggregate unit may enhance transmission efficiency by reducing protocol overhead and efficiently using the available bandwidth.

Finally, at step 424, the networking device transmits the aggregated data unit to the intended recipients. This involves queuing the aggregated data unit for transmission, using network interfaces such as transceivers, for example. The networking device employs appropriate transmission protocols, such as Wi-Fi, to ensure successful delivery.

Referring to FIG. 5, FIG. 5 depicts an example compact header 500. The compact header 500 of FIG. 5 may be an example representative of the “compact header” as generated by an example networking device based on a full header. The compact header 500 may include an availability bitmap 502, a first session identifier 504, and selected header fields 506-524. As previously noted, the availability bitmap 502 may provide a concise way to indicate which header fields from an original full header have been included in the compact header and which header fields have been omitted. In particular, the availability bitmap 502 may be a series of bits, with each bit representing the presence or absence of a corresponding header field of the second header (e.g., an original header of a second data unit described in conjunction with earlier Figures) in the compact header. This allows the receiving device to efficiently restore the original header when necessary. Further, the first session identifier 504 may be a unique identifier for the traffic session associated with the first data unit and the second data unit (e.g., a session identifier generated at step 406).

The selected header fields 506-524 may include the header fields that are unique to the second header of the second data unit compared to the first header of the first data unit. In an example use case depicted in FIG. 5, the second data unit is identified to include a unique content in the header fields such as ‘tos,’ ‘tot_len,’ ‘frag_off,’ and ‘ttl’ of the IP header, ‘seq,’ ‘ack_seq,’ ‘flag,’ ‘window,’ and ‘urg_ptr’ in the TCP header, and ‘len’ in the UDP header. Accordingly, the compact header 500 is shown to include these fields, while the rest of the fields of the respective headers may be determined as the candidate header fields and, therefore, be removed.

For example, the header fields 506, 508, 510, 512, and 514 of the compact header 500 may respectively represent the header fields ‘tos,’ ‘tot_len,’ ‘frag_off,’ and ‘ttl’ of the IP header that are not redundant between the first header and the second header. Similarly, the header fields 516, 518, 520, 522, and 524 of the compact header 500 may respectively represent the header fields ‘seq,’ ‘ack_seq,’ ‘flag,’ ‘window,’ and ‘urg_ptr’ of the TCP header that are not redundant between the first header and the second header. Finally, the header field 526 of the compact header 500 may represent the header field ‘len’ of the UDP header that is unique to the second header. It may be noted that the header fields depicted in the compact header 500 of FIG. 5 are for illustration purposes only. In reality, the compact header 500 may include those fields that remain unique to the second header in comparison to the first header. Accordingly, the number of header fields in the compact header 500 may also be different in some examples.

FIG. 6 depicts an example aggregated data unit, such as an example A-MPDU 600. The A-MPDU 600 may represent an aggregated data unit that may be transmitted by a networking device (e.g., the AP 100 of FIG. 1) at steps 314 of FIG. 3 or step 424 of FIG. 4. In some examples, the A-MPDU 600 may represent an aggregated data unit that may be received by a receiving device (e.g., the receiving device 200 of FIG. 2) at step 702 of FIG. 7 or step 802 of FIG. 8.

The A-MPDU 600 includes a PHY header 602 and a data unit section 604. The PHY header 602 of the A-MPDU 600 plays a useful role in preparing a receiving device to receive and decode the A-MPDU 600. It provides synchronization, channel estimation, and certain additional information about the frame structure and transmission parameters, ensuring robust and efficient wireless communication.

Further, the data unit section 604 of the A-MPDU 600 includes one or more data units, for example, MPDUs in the present case. For illustration purposes, the data unit section 604 is depicted to include two data units, such as a first data unit 606 (also referred to as a first MPDU) and a second data unit 608 (also referred to as a second MPDU). As will be appreciated, the data unit section 604 may include more data units within a maximum transmission unit (MTU) size and other relevant protocol constraints. Further, in some examples, in the A-MPDU, adjacent MPDUs are separated via a delimiter, for example, a delimiter 610. The delimiter 610 may represent a predefined set of bytes added between individual MPDUs and act as a marker to separate one MPDU from another within the A-MPDU.

As previously noted in the description, the first data unit 606 may include a first header 612 and a first data payload 614, whereas the second data unit 608 may include a compact header 616 and a second data payload 618. The first header 612 may be in the original full form, whereas the compact header 616 is generated by removing certain redundant header fields from a second header of the second data unit (see steps 308-312 of FIG. 3 and steps 412-416 of FIG. 4). In one example, the compact header 616 may be similar to the compact header 500 depicted in FIG. 5.

In the description hereinafter, various operations performed by a networking device, referred to as a receiving device (e.g., the receiving device 200 of FIG. 2) that receives data units with compact headers are described with the help of flowcharts depicted in FIGS. 7 and 8. In some examples, the receiving device may be a wireless networking device such as an AP, a radio router, a radio transceiver, a switch, a Wi-Fi hotspot device, a BSS device, an ESS device, a radio base station, a WLAN controller, a gateway device, and the like. In some examples, the receiving device may be a client device capable of communicating with a wireless networking device, such as the AP 100 of FIG. 1. In certain examples, the functionalities of the receiving device may be embedded into the AP 100 of FIG. 1 to enable the AP 100 to restore the headers of the aggregated data units it may receive.

In particular, FIGS. 7 and 8 depict flowcharts of example methods for restoring a full header from a compact header by a receiving device responsive to receiving the data units with compact headers. The steps that are shown in FIGS. 7 and 8 may be performed locally at any suitable device, such as a receiving device, for example, the receiving device 200 of FIG. 2. In some examples, a suitable device may include a processing resource suitable for the retrieval and execution of instructions (e.g., the instructions 208) stored in a machine-readable storage medium. The processing resource and the machine-readable storage medium may be example representatives of the processing resource 202 and the machine-readable storage medium 204 of the receiving device 200 of FIG. 2. As an alternative or in addition to retrieving and executing instructions, the processing resource may include one or more electronic circuits that include electronic components for performing the functionality of one or more instructions, such as an FPGA, ASIC, or other electronic circuits. Further, the flow charts that are shown in FIGS. 7 and 8 include several steps in a particular order. However, the order of steps shown in the respective flowcharts should not be construed as the only order for the steps. The steps may be performed at any time in any order. Additionally, the steps may be repeated or omitted as needed.

Referring now to FIG. 7, a flowchart of example method 700 for restoring a full header from a compact header is presented.

At step 702, a receiving device receives an aggregated data unit comprising a first data unit and a second data unit. In some examples, the aggregated data unit may be either an A-MPDU or an A-MSDU. This aggregated data unit comprises at least a first data unit and a second data unit. The first data unit includes a first header, which is a full header containing all necessary fields for proper identification and routing of the data unit. The second data unit includes a compact header (e.g., the compact header generated at the step 308 of FIG. 3 or the step 412 of FIG. 4), which has been optimized to reduce redundancy and improve transmission efficiency. As previously noted, the compact header contains an availability bitmap (i.e., a series of bits indicating the presence or absence of specific header fields) and a first session identifier (i.e., identification information that can uniquely identify the traffic session to which the data unit belongs). On receiving the aggregated data unit, the receiving device stores the aggregated data unit in an appropriate buffer (e.g., an incoming data buffer) and parses the data units to extract the headers.

Further, at step 704, the receiving device generates a verification session identifier based on the first header of the first data unit. This process involves extracting certain session-specific parameters from the first header, such as the source IP address, destination IP address, source port, destination port, and protocol type. These session-specific parameters uniquely identify the traffic session. The receiving device applies the same predefined hash function used by the transmitting device to these extracted session-specific parameters to generate the verification session identifier. This ensures consistency and accuracy in session identification. The verification session identifier serves as a reference to validate the session context of the second data unit. The hash function is designed to produce the same output for the same input fields, ensuring that the verification session identifier matches the first session identifier in the compact header if both data units indeed belong to the same session.

Furthermore, at step 706, the receiving device may identify one or more candidate header fields from the compact header for restoration in response to determining that the verification session identifier matches the first session identifier. This identification is based on the availability bitmap, which indicates which fields are present or absent in the compact header. The receiving device compares the verification session identifier generated in step 704 with the first session identifier extracted from the compact header. If the identifiers match, it confirms that the first and second data units belong to the same session, and the header restoration can proceed. The receiving device then uses the availability bitmap to determine which specific header fields are to be restored. The bitmap provides a bitwise representation where each bit corresponds to a header field, with a ‘1’ indicating the presence and a ‘0’ indicating the absence of the field, or vice-versa. This step ensures that only the necessary fields are restored, maintaining the compact header's efficiency.

Moreover, at step 708, the receiving device may restore a second header by populating one or more candidate header fields in the compact header from respective header fields of the first header. In particular, the receiving device copies the values of the missing fields of the compact header from the first header to their appropriate positions in the compact header. The receiving device uses the availability bitmap as a guide to determine which fields need to be copied from the first header and inserted into the compact header. This restoration process ensures that the second header is fully reconstructed, containing all necessary information for proper routing and processing. The restored second header now includes fields that were previously omitted while creating the compact header.

Then, at step 710, the receiving device may replace the compact header in the second data unit with the reconstructed second header. In particular, this step involves the receiving device modifying the second data unit in the incoming data buffer to ensure that the restored second header is correctly placed and aligned. The receiving device updates any necessary pointers or offsets to reflect the changes in header size and structure. By replacing the compact header with the fully restored second header, the receiving device ensures that the second data unit is now complete and ready for further processing or forwarding. The receiving device then proceeds to process or forward the data unit according to its networking protocols and policies.

Turning now to FIG. 8, a flowchart of another example method 800 for restoring a full header from a compact header is presented. The method 800 may be performed by a receiving device, for example, the receiving device 200 of FIG. 2. The method 800 of FIG. 8 includes certain steps that are similar to those described in FIG. 7, certain details of which are not repeated herein for the sake of brevity.

At step 802, the receiving device receives an aggregated data unit comprising a first data unit and a second data unit. The aggregated data unit includes at least a first data unit and a second data unit, wherein the first data unit includes a first header which is a full header containing all necessary fields for proper identification and routing of the data unit, and the second data unit includes a compact header (e.g., the compact header generated at the step 308 of FIG. 3 or the step 412 of FIG. 4) containing an availability bitmap and a first session identifier.

At step 804, the receiving device extracts the first data unit and the second data unit from the aggregated data unit. This involves parsing the aggregated data unit's structure to identify and separate the individual data units. For an A-MPDU, the receiving device locates the delimiters in the A-MPDU to extract each MPDU. For an A-MSDU, the receiving device separates the individual MSDUs from the single MPDU payload. The extracted data units are stored in appropriate memory buffers, for example, an incoming data buffer, for further processing, ensuring their integrity and readiness for subsequent header restoration steps.

Further, at step 806, the receiving device generates a verification session identifier based on the first header of the first data unit, similarly as described in conjunction with FIG. 7. The verification session identifier serves as a reference to validate the session context of the second data unit. Furthermore, at step 808, the receiving device may identify one or more candidate header fields from the compact header for restoration in response to determining that the verification session identifier matches the first session identifier. This identification is based on the availability bitmap, which indicates which fields are present or absent in the compact header. The receiving device compares the verification session identifier generated in step 806 with the first session identifier extracted from the compact header. If the identifiers match, it confirms that the first and second data units belong to the same session, and the header restoration can proceed. The receiving device then uses the availability bitmap to determine which specific header fields are to be restored.

After the candidate header fields are identified, the receiving device may restore a second header by populating one or more candidate header fields in the compact header from respective header fields of the first header. This restoration process entails the receiving device executing the steps 810 and 812, for example. In particular, at step 810, the receiving device copies the content of one or more candidate header fields from the first header. This involves accessing the first data unit's full header and retrieving the values of the candidate header fields that were identified for restoration in step 808. The receiving device reads the appropriate fields based on the availability bitmap, ensuring that it captures all necessary information required for reconstructing the second header. Further, at step 812, the receiving device inserts the content of the one or more candidate header fields into the compact header, thereby generating the second header. This involves placing the copied content from step 810 into the appropriate positions within the compact header. The device carefully reconstructs the second header by filling in the missing fields, guided by the availability bitmap. The result is a fully restored second header that contains all necessary fields for the proper identification, routing, and processing of the second data unit. This step ensures the integrity and completeness of the second data unit, enabling it to be handled correctly by subsequent network nodes.

After the second header is restored, the receiving device, at step 814, may replace the compact header in the second data unit with the second header. This step involves modifying the second data unit in the incoming data buffer to ensure that the restored header is correctly placed and aligned. By replacing the compact header with the fully restored second header, the receiving device ensures that the second data unit is now complete and ready for further processing or forwarding.

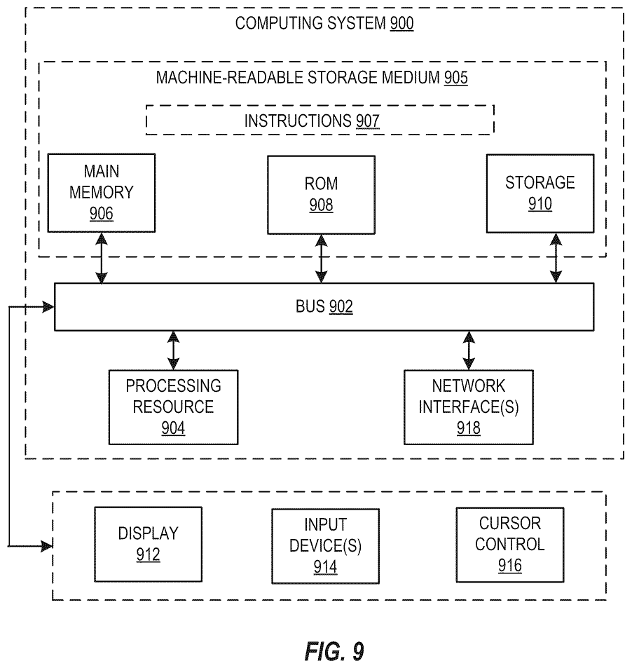

FIG. 9 depicts a block diagram of an example computing system 900 in which various of the examples described herein may be implemented. In some examples, the computing system 900 may be configured to operate as a wireless networking device, for example, an AP (e.g., the AP 100 of FIG. 1) or a receiving device (e.g., the receiving device 200 of FIG. 2) can perform various operations described in one or more of the earlier drawings.

The computing system 900 may include a bus 902 or other communication mechanisms for communicating information, a hardware processor, also referred to as processing resource 904, and a machine-readable storage medium 905 coupled to the bus 902 for processing information. In some examples, the processing resource 904 may include one or more CPUs, semiconductor-based microprocessors, and/or other hardware devices suitable for retrieval and execution of instructions stored in a machine-readable storage medium 905. The processing resource 904 may fetch, decode, and execute instructions, to generate compact headers for data units and/or restore the full headers from the compact headers, in accordance with examples presented herein. As an alternative or in addition to retrieving and executing instructions, the processing resource 904 may include one or more electronic circuits that include electronic components for performing the functionality of one or more instructions, such as an FPGA, an ASIC, or other electronic circuits.

In some examples, the machine-readable storage medium 905 may include a main memory 906, such as a RAM, cache, and/or other dynamic storage devices, coupled to the bus 902 for storing information and instructions to be executed by the processing resource 904. The main memory 906 may also be used for storing temporary variables or other intermediate information during the execution of instructions to be executed by the processing resource 904. Such instructions, when stored in storage media accessible to the processing resource 904, render the computing system 900 into a special-purpose machine that is customized to perform the operations specified in the instructions. The machine-readable storage medium 905 may further include a read-only memory (ROM) 908 or other static storage device coupled to the bus 902 for storing static information and instructions for the processing resource 904. Further, in the machine-readable storage medium 905, a storage device 910, such as a magnetic disk, optical disk, or USB thumb drive (Flash drive), etc., may be provided and coupled to the bus 902 for storing information and instructions.

Further, in some implementations, the computing system 900 may be coupled, via the bus 902, to a display 912, such as a liquid crystal display (LCD) (or touch-sensitive screen), for displaying information to a computer user. In some examples, an input device 914, including alphanumeric and other keys (physical or software generated and displayed on a touch-sensitive screen), may be coupled to the bus 902 for communicating information and command selections to the processing resource 904. Also, in some examples, another type of user input device may be a cursor control 916, such as a mouse, a trackball, or cursor direction keys that may be connected to the bus 902. The cursor control 916 may communicate direction information and command selections to the processing resource 904 for controlling cursor movement on the display 912. In some other examples, the same direction information and command selections as cursor control may be implemented via receiving touches on a touch screen without a cursor.

In some examples, the computing system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 900 also includes a network interface 918 coupled to bus 902. The network interface 918 provides a two-way data communication coupling to one or more network links that are connected to one or more local networks. For example, the network interface 918 may be an integrated services digital network (ISDN) card, cable modem, satellite modem, or a modem to provide a data communication connection to a corresponding type of telephone line. As another example, the network interface 918 may be a local area network (LAN) card or a wireless communication unit (e.g., Wi-Fi chip/module).

In some examples, the machine-readable storage medium 905 (e.g., one or more of the main memory 906, the ROM 908, or the storage device 910) stores instructions 907 which when executed by the processing resource 904 may cause the processing resource 904 to execute one or more of the methods/operations described hereinabove. The instructions 907 may be stored on any of the main memory 906, the ROM 908, or the storage device 910. In some examples, the instructions 907 may be distributed across one or more of the main memory 906, the ROM 908, or the storage device 910. In some examples, when the computing system 900 is configured to operate as an AP (e.g., the AP 100 that transmits the data units with compact headers), the instructions 907 may include instructions which when executed by the processing resource 904 may cause the processing resource 904 to perform one or more of the methods described in FIGS. 3 and 4. In some examples, when the computing system 900 is configured to function as a receiving device (e.g., the receiving device 200 receives the data units with compact headers), the instructions 907 may include instructions which when executed by the processing resource 904 may cause the processing resource 904 to perform one or more of the methods described in FIGS. 7 and 8.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, etc., may be used herein to describe various elements, these elements should not be limited by these terms, as these terms are only used to distinguish one element from another unless stated otherwise or the context indicates otherwise.

What is claimed is:

1. A method for efficiently transmitting data units, comprising:
receiving, by a networking device, a first data unit of a first session, wherein the first data unit comprises a first header;
receiving, by the networking device, a second data unit of the first session, wherein the second data unit comprises a second header;
identifying, by the networking device, one or more candidate header fields having similar information in both the first header and the second header;
generating, by the networking device, a compact header by removing content of the one or more candidate header fields from the second header;
inserting, by the networking device, an availability bitmap into the compact header, wherein the availability bitmap comprises a flag corresponding to one or more header fields of the second header indicating whether respective content is present in the compact header;
replacing, by the networking device, the second header in the second data unit with the compact header; and
transmitting, by the networking device, the first data unit comprising the first header and the second data unit comprising the compact header.

2. The method of claim 1, further comprising:
generating, by the networking device, a first session identifier corresponding to the first session based on the first data unit; and
storing, by the networking device, the first data unit in a transmission queue corresponding to the first session identifier.

3. The method of claim 2, wherein generating the first session identifier comprises generating a hash value by applying a predefined hash function to one or more header fields of the first header.

4. The method of claim 2, wherein generating the compact header further comprises inserting the first session identifier in the compact header.

5. The method of claim 4, further comprising storing, by the networking device, the second data unit in the transmission queue after replacing the second header in the second data unit with the compact header.

6. The method of claim 5, wherein the transmitting comprises:
generating, by the networking device, an aggregated data unit comprising the first data unit having the first header and the second data unit having the compact header; and
transmitting, by the networking device, the aggregated data unit.

7. The method of claim 6, wherein each of the first data unit and the second data unit is a Media Access Control Protocol Data Unit (MPDU) and the aggregated data unit is an Aggregated-MPDU (A-MPDU).

8. The method of claim 6, wherein each of the first data unit and the second data unit is a Media Access Control Service Data Unit (MSDU) and the aggregated data unit is an Aggregated-MSDU (A-MSDU).

9. The method claim 8, further comprising:
receiving, by a second networking device, the aggregated data unit;
extracting, by the second networking device, the first data unit and the second data unit from the aggregated data unit;
generating, by the second networking device, a verification session identifier based on the first header of the first data unit; and
restoring, by the second networking device, the second header from the compact header using the availability bitmap and the first header in response to determining that the verification session identifier matches the first session identifier.

10. The method of claim 9, wherein restoring the second header comprises:
identifying, by the second networking device, the one or more candidate header fields based on the availability bitmap;
copying, by the second networking device, content of the one or more candidate header fields from the first header; and
inserting, by the second networking device, the content of the one or more candidate header fields into the compact header thereby generating the second header at the second networking device.

11. An access point (AP) comprising:
a machine-readable storage medium storing executable instructions; and
a processing resource connected to the machine-readable storage medium and configured to execute one or more of the instructions to:
receive a first data unit of a first session, wherein the first data unit comprises a first header;
receive a second data unit of the first session, wherein the second data unit comprises a second header;
identify one or more candidate header fields having similar information in both the first header and the second header;
generate a compact header by removing content of the one or more candidate header fields from the second header;
insert an availability bitmap into the compact header, wherein the availability bitmap comprises a flag corresponding to one or more header fields of the second header indicating whether respective content is present in the compact header;
replace the second header in the second data unit with the compact header; and
transmit the first data unit comprising the first header and the second data unit comprising the compact header.

12. The AP of claim 11, wherein the processing resource is configured to execute one or more of the instructions to:
generate a first session identifier corresponding to the first session based on the first data unit; and
store the first data unit in a transmission queue corresponding to the first session identifier.

13. The AP of claim 12, wherein to generate the first session identifier the processing resource is configured to execute one or more of the instructions to generate a hash value by applying a predefined hash function to one or more header fields of the first header.

14. The AP of claim 12, wherein the compact header comprises the first session identifier.

15. The AP of claim 14, wherein the processing resource is configured to execute one or more of the instructions to store the second data unit in the transmission queue after replacing the second header in the second data unit with the compact header.

16. The AP of claim 15, wherein to transmit the first data unit and the second data unit, the processing resource is configured to execute one or more of the instructions to:
generate an aggregated data unit comprising the first data unit having the first header and the second data unit having the compact header; and
transmit the aggregated data unit.

17. The AP of claim 16, wherein the aggregated data unit is an Aggregated-MPDU (A-MPDU) or an Aggregated-MSDU (A-MSDU).

18. A method for restoring header information in data units, comprising:
receiving, by a networking device, an aggregated data unit comprising a first data unit and a second data unit, wherein the first data unit comprises a first header and the second data unit comprises a compact header, wherein the compact header comprises an availability bitmap and a first session identifier;
generating, by the networking device, a verification session identifier based on the first header of the first data unit;
identifying, by the networking device, one or more candidate header fields from the compact header for restoration based on the availability bitmap in response to determining that the verification session identifier matches the first session identifier;
restoring, by the networking device, a second header by populating the one or more candidate header fields in the compact header from respective header fields of the first header; and
replacing, by the networking device, the compact header in the second data unit with the second header.

19. The method of claim 18, wherein restoring the second header comprises:
copying, by the networking device, content of the one or more candidate header fields from the first header; and
inserting, by the networking device, the content of the one or more candidate header fields into the compact header, thereby generating the second header at the networking device.

20. The method of claim 18, wherein the aggregated data unit is an Aggregated-MPDU (A-MPDU) or an Aggregated-MSDU (A-MSDU).
